(19) United States
(12) Patent Application Publication
(10) Pub. No.: US 2005/0251795 A1
(43) Pub. Date: Nov. 10, 2005

(54) Method, system, and program for optimizing code

(75) Inventors: Mariano G. Fernandez, Weston, MA (US); James D. Guilford, Northborough, MA (US)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/805,106

(22) Filed: Mar. 19, 2004

(51) Int. Cl. G06F 7/38

(52) U.S. Cl. 717/151

(57) ABSTRACT

Provided are a method, system, and program for optimizing code. A program is accessed comprising a plurality of instructions including at least one no operation (NOP) instruction. At least one NOP instruction in the program that is not needed to provide a processing delay to ensure data is available to at least one dependent instruction accessing the data is removed.

### BACKGROUND

Assembly language and microengine code is closely related to the computer's machine language code and comprises a mnemonic version of machine code, in which names are used instead of binary codes for operations, and names are also given for memory addresses. When writing assembly language code or microengine code, programmers take into account pipeline delays. A pipeline delay refers to the delay in the availability in memory or registers of the results of the execution of a previous instruction. For instance, the processor may execute a write or load instruction in one cycle, but the write data may not be available to subsequent instructions for several cycles. In this way, the write instruction takes several cycles to propagate through the execution pipeline. Programmers adding subsequent instructions depending on the availability of the data subject to the pipeline delay must ensure that such dependent instructions do not access the data before the required data is available, or before the write of the data propagates through the pipeline, which occurs when the data is finally written to the target location. The programmer may insert no operation (NOP) instructions to cause the processor to delay for a number of cycles equivalent to the pipeline delay to ensure that the data is available before executing dependent instructions that depend on such data. The NOP instructions allow an instruction dependent on data written by a previous instruction to remain in the pipeline until the data is available, which occurs when the instruction writing the dependent data has completed propagating through the pipeline.

Although inserting NOP instructions allows the programmer to avoid errors resulting from a dependent instruction accessing the wrong data, processor cycles are wasted processing the NOP instructions. Moreover, programmers may add more NOP instructions than needed into their code, resulting in an unnecessary decrease in processor performance.

### BRIEF DESCRIPTION OF THE DRAWINGS

FIG. 1 illustrates a computing environment in accordance with the described embodiments;

FIGS. 2, 3, and 4 illustrate operations performed to optimize code in accordance with the described embodiments; and

FIG. 5 illustrates an architecture of a network processor.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

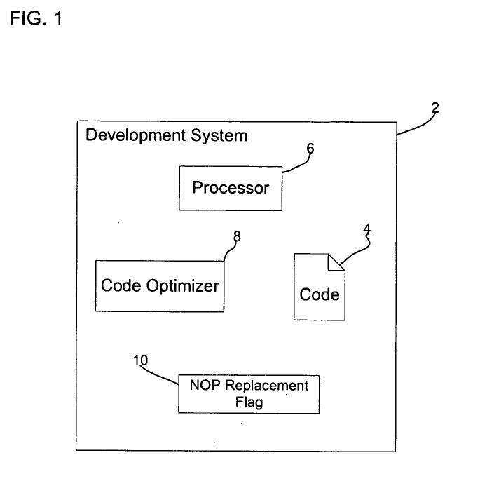

FIG. 1 illustrates a computing environment. A development system 2 is used by a programmer or software developer to create code 4. In certain embodiments, the code 4 comprises assembly language or programmable engine code. The development system 2 includes one or more processors 6 and a code optimizer 8 program executed by the processor 6. The developer invokes the code optimizer 8 to optimize the positioning and placement of the instructions in the code 4, including NOP instructions inserted by the developer. The code optimizer 8 may be part of an assembler program that translates assembly instructions into executable code. In alternative embodiments, the code optimizer 8 may process assembly language code generated by a compiler translating higher level source code, such as object oriented code. The development system 2 may comprise a computer workstation, laptop, desktop, server, mainframe or any other computing device suitable for developing code 4.

The developer generated code 4 may include no operation (NOP) instructions that the developer adds to delay the processing of dependent instructions in the pipeline to ensure that data is ready and available to dependent instructions dependent on such data. The developer may then invoke the code optimizer 8 to remove NOP statements and/or rearrange statements to replace NOP statements to optimize the code 4 by filling the pipeline delays.

In certain embodiments, the code optimizer 8 may be part of a suite of programmable engine or assembler development tools providing an integrated development environment (IDE) for simulation, profiling, and debugging.

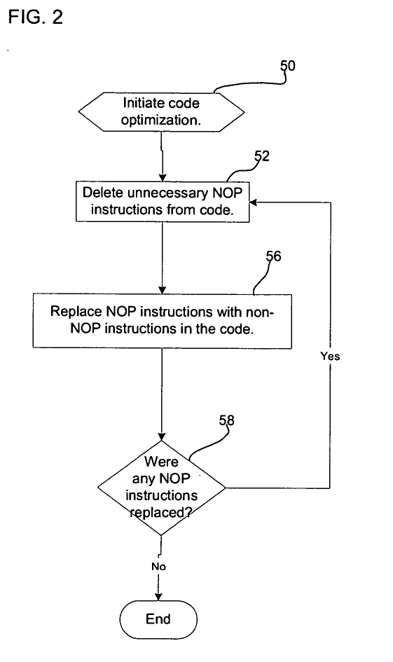

FIGS. 2, 3, and 4 illustrate operations performed by the code optimizer 8 to remove NOP instructions to minimize pipeline delays and optimize the processing of the code 4. With respect to FIG. 2, control begins with the developer invoking the code optimizer 8 (at block 50) to remove NOP instructions. The code optimizer 8 then initiates operations to delete (at block 52) unnecessary NOP instructions from the code 4 and then replaces (at block 56) NOP instructions with non-NOP instructions in the code 4, which may involve moving a non-NOP instruction to replace an NOP instruction. If (at block 58) NOP instructions were replaced at block 56, then, in certain embodiments, control proceeds back to block 52 to again delete any unnecessary NOP instructions that are not providing a necessary pipeline delay ensuring the availability of data to a dependent instruction requiring such data. If (at block 58) the replace operation is not performed, then the optimization process may end.

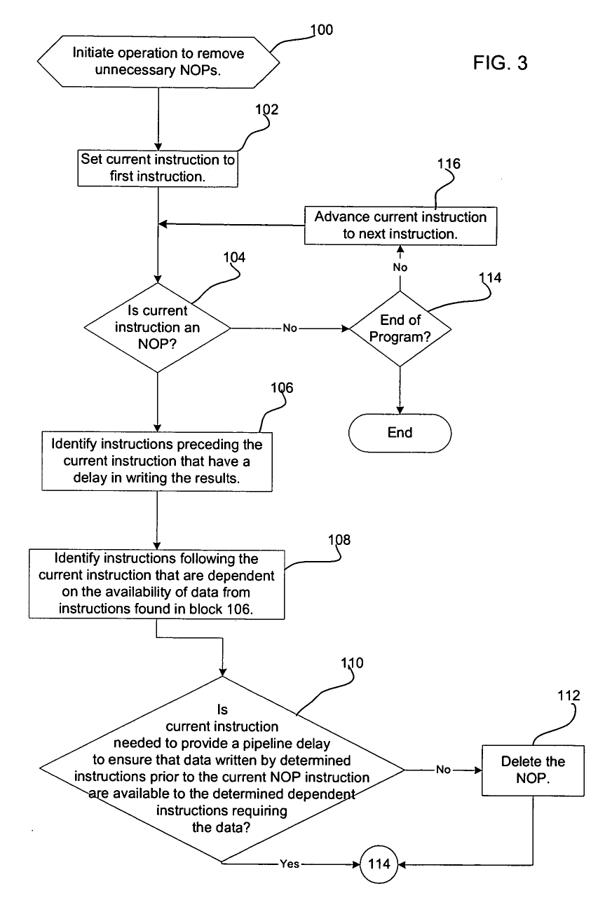

FIG. 3 illustrates operations performed by the code optimizer 8 to delete any unnecessary NOPs in the code 4, which procedure may be invoked from block 52 in FIG. 2. Upon invoking the delete NOP operation (at block 100), the current instruction is set to the first instruction in the code 4 (at block 102). The current instruction may comprise a pointer to an instruction to which the current instruction is set. If (at block 104) the current instruction is an NOP instruction, then the code optimizer 8 identifies (at block 106) instructions preceding the current instruction that have a delay, such as a pipeline delay, in writing results and identifies (at block 108) instructions following the current instruction that are dependent on the availability of data from instructions found in block 106. If (at block 110) the current NOP instruction is not needed to provide a pipeline delay to ensure that data written by determined instructions prior to the current instruction is available to the determined dependent instructions that require such written data, then the NOP is deleted (at block 112). If the current NOP instruction is needed to provide the necessary pipeline delay (from the yes branch of block 110) or after deleting the current NOP instruction (at block 112), then control proceeds to block 114 to determine whether the current instruction was the last in the code 4. If so, then control ends; otherwise, the current instruction is advanced (at block 116) to the next instruction in the code 8 and then control proceeds back to block 104 to consider further NOP instructions to delete.

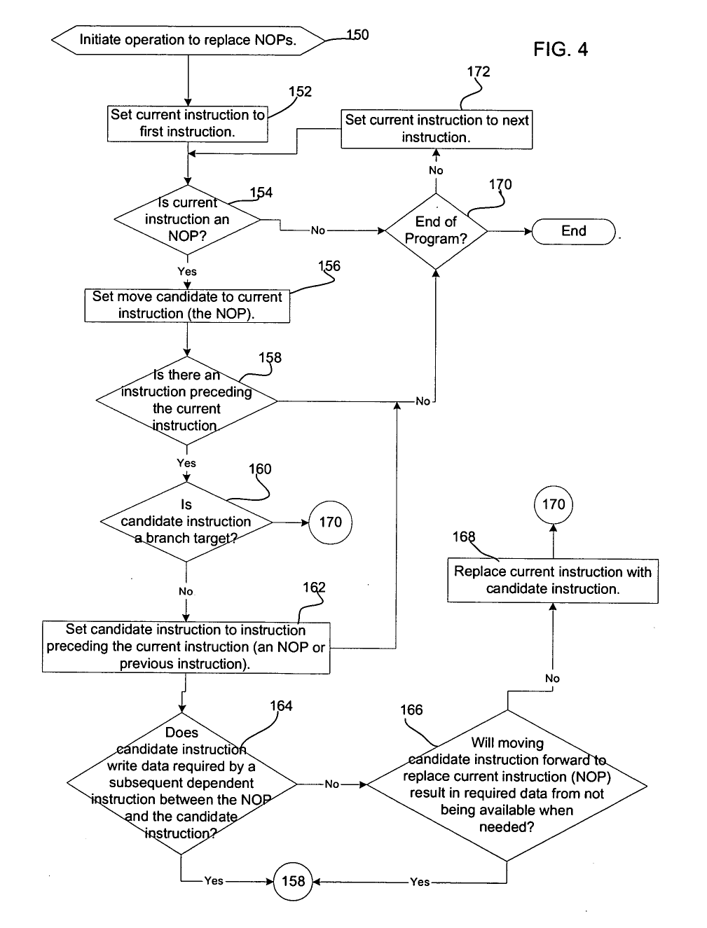

FIG. 4 illustrates operations performed by the code optimizer 8 to replace any unnecessary NOPs in the code 4 with non-NOP instructions, which procedure may be invoked from block 56 in FIG. 2. Upon invoking the replace NOP operation (at block 150), the current instruction is set (at block 152) to the first instruction in the code 4. If (at block 154) the current instruction is an NOP instruction, then the move candidate is set (at block 156) to the current instruction (the NOP). If (at block 158) there is no instruction preceding the current instruction, which may comprise a previously accessed current instruction or an NOP instruction, and if (at block 160) the candidate instruction is a branch target instruction, then control proceeds to block 170 to consider a further NOP instruction to replace. The branch instruction may be conditional or non-conditional. Otherwise, if (at block 160) the instruction is not a branch target instruction, then the code optimizer 8 sets (at block 162) a candidate instruction to the instruction preceding the current instruction. The current instruction and candidate instruction may comprise pointers to an instruction in the code 8 to which the pointers are set. The current instruction may comprise an NOP or the candidate instruction, i.e., preceding non-NOP instruction.

If (at block 164) the candidate instruction writes data required by a subsequent dependent instruction between the current instruction (NOP) and candidate instruction, then control proceeds to block 158 to consider a further previous instruction to move down to replace the current instruction (NOP). Otherwise, if (at block 164) the candidate instruction does not write data required by a subsequent dependent instruction and if (at block 166) moving the candidate instruction forward to replace the current instruction (NOP) will not result in required data being unavailable to a dependent instruction, then the current instruction is replaced (at block 168) with the candidate instruction and control proceeds to block 170 to consider the next NOP instruction for replacement. Otherwise, if (at block 166) replacing the current instruction with the candidate instruction will result in required data being unavailable when needed, then control proceeds to block 158 to consider a further previous instruction to move down to replace the current instruction (NOP). For instance, moving the instruction forward in the code 4 may cause the data needed by one dependent instruction to be written in fewer cycles from the dependent instruction, where the number of cycles now between the writing instruction and dependent instruction are not sufficient to guarantee that the written data will be available to the dependent instruction.

Described embodiments provide techniques to optimize program instructions, such as assembly language or other instructions that include NOP instructions by removing NOP instructions and the processor delay associated with processing the NOP instructions.

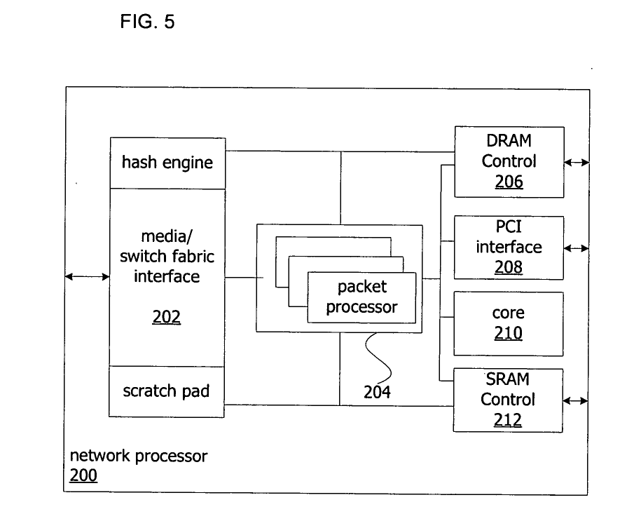

In certain embodiments, the code optimizer 8 may be used to optimize assembly code written for microengines used within a network processor. FIG. 5 illustrates an example of network processor 200. The network processor 200 shown is an Intel® Internet eXchange network Processor (IXP). Other network processors feature different designs. The network processor 200 shown features a collection of packet engines 204. The packet engines 204 may be Reduced Instruction Set Computing (RISC) processors tailored for packet processing. For example, the packet engines 204 may not include floating point instructions or instructions for integer multiplication or division commonly provided by general purpose processors. The network processor 200 components may be implemented on a single integrated circuit die.

An individual packet engine 204 may offer multiple threads. For example, the multi-threading capability of the packet engines 204 may be supported by hardware that reserves different registers for different threads and can quickly swap thread contexts. In addition to accessing shared memory, a packet engine may also feature local memory and a content addressable memory (CAM). The packet engines 204 may communicate with neighboring processors 204, for example, using neighbor registers wired to the adjacent engine(s) or via shared memory.

The network processor 200 also includes a core processor 210 (e.g., a StrongARM® XScale®) that is often programmed to perform “control plane” tasks involved in network operations. (StrongARM and XScale are registered trademarks of Intel Corporation). The core processor 210, however, may also handle “data plane” tasks and may provide additional packet processing threads.

As shown, the network processor 200 also features interfaces 202 that can carry packets between the processor 200 and other network components. For example, the processor 200 can feature a switch fabric interface 202 (e.g., a CSIX interface) that enables the processor 200 to transmit a packet to other processor(s) or circuitry connected to the fabric. The processor 200 can also feature an interface 202 (e.g., a System Packet Interface Level 4 (SPI-4) interface) that enables to the processor 200 to communicate with physical layer (PHY) and/or link layer devices. The processor 200 also includes an interface 208 (e.g., a Peripheral Component Interconnect (PCI) bus interface) for communicating, for example, with a host. As shown, the processor 200 also includes other components shared by the engines such as memory controllers 206, 212, a hash engine, and scratch pad memory.

The packet processing techniques described above may be implemented on a network processor, such as the IXP, in a wide variety of ways. For example, one or more threads of a packet engine 204 may execute instructions for updating and/or reading the network statistics. Additionally, the memory locations storing the network statistics may be distributed across the memory sub-systems in a variety of ways (e.g., lower portions in SRAM, higher portions in higher latency DRAM). Further, for even faster access, the lower portions of the statistic counters may be cached in the local memory of a packet engine performing statistic updates or reads. To identify which portions have been cached, the addresses of cached counter portions may be stored in an engine's CAM.

In certain embodiments, the code optimizer 8 described herein may be used to optimize assembly code a user writes to run the programmable engines performing the operations of the components of the network processor 200, such as the media/switch fabric interface 202, packet processor 204, DRAM control 206, PCI interface 208, core 210, and SRAM control 212. The assembly code running the programmable engines or microengines of the network processor 200 may thus be optimized by the code optimizer 8 described above to remove NOPs and avoid any unnecessary delays in network processor 200 programmable engine operations.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to-either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In the described embodiments, the code optimizer is applied to assembly language code generated by the developer. In alternative embodiments, the code 4 may be generated by a compiler processing a source program.

In the described embodiments, the code optimizer was used to optimize the placement of NOP instructions in assembly language code. In alternative embodiments, the described code optimizer may apply to programming languages including a NOP type instruction, including high level and object oriented languages.

In certain embodiments, the code optimizer 8 was used to optimize assembly code for microengines in a network processor. In additional embodiments, the code optimizer 8 may be used to optimize assembly code for different types of processors, including central processing units, Input/Output controllers, storage controllers, etc.

The illustrated operations of FIGS. 2, 3, and 4 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit the embodiments to the precise form disclosed. Many modifications and variations are possible in light of the above teaching.

1. A method implemented in circuitry, comprising:
accessing a program comprising a plurality of instructions including at least one no operation (NOP) instruction; and
removing at least one NOP instruction in the program that is not needed to provide a processing delay to ensure data is available to at least one dependent instruction accessing the data.

2. The method of claim 1, wherein removing the at least one NOP instruction comprises at least one of:
deleting one NOP instruction in the program that is not needed to provide the processing delay to ensure the data is available to at least one dependent instruction without moving a non-NOP instruction; and
replacing one NOP instruction with one determined instruction preceding the NOP instruction in response to determining that one instruction preceding at least one NOP instruction is capable of replacing the NOP instruction in the program.

3. The method of claim 1, further comprising:
deleting at least one instruction in the program that is not needed to provide the processing delay to ensure the data is available to at least one dependent instruction; and
after deleting the at least one instruction, replacing at least one NOP instruction with one determined instruction preceding the at least one NOP instruction in response to determining that one instruction preceding at least one NOP instruction is capable of replacing the NOP instruction in the program.

4. The method of claim 3, further comprising:
performing an additional iteration of deleting at least one instruction and then replacing the at least one NOP instruction in response to replacing at least one NOP instruction.

5. The method of claim 1, wherein the instructions in the program comprise assembly language instructions coded by a developer.

6. The method of claim 1, wherein removing NOP instructions in the program further comprises accessing and processing each NOP instruction by:
determining whether the accessed NOP instruction is needed to delay processing of one dependent instruction following the accessed NOP instruction to ensure that data is available to the dependent instruction accessing the data; and
deleting the accessed NOP instruction in response to determining that the NOP instruction is not needed to ensure that data is available to the dependent instruction accessing the data.

7. The method of claim 6, wherein determining whether the accessed NOP instruction is needed to delay processing of one dependent instruction further comprises:
identifying instructions preceding the NOP instruction that have a delay in writing the results and
identifying dependent instructions following the NOP instruction that are dependent on an availability of data from the identified instructions having the delay in writing the results.

8. The method of claim 1, wherein removing NOP instructions in the program further comprises accessing and processing each NOP instruction by:
replacing the accessed NOP instruction with one previous non-NOP instruction that is capable of being moved forward to replace the accessed NOP instruction without preventing data from being available to one dependent instruction following the NOP instruction.

9. The method of claim 8, wherein the one previous instruction comprises a preceding instruction closest to the accessed NOP instruction in the program.

10. The method of claim 8, wherein removing the NOP instructions further comprises:
deleting at least one NOP instruction not needed to ensure that data accessed by the dependent instruction is available to the dependent instruction, wherein the operations of replacing accessed NOP instructions with previous non-NOP instructions are performed after deleting NOP instructions not needed to ensure that data accessed by the dependent instruction is available.

11. The method of claim 1, wherein removing NOP instructions in the program further comprises accessing each NOP instruction and performing:
replacing the accessed NOP instruction with one previous non-NOP instruction that is capable of being moved forward to replace the accessed NOP instruction without preventing data from being available to one dependent instruction following the NOP instruction and that is not a branch target instruction.

12. The method of claim 1, wherein the program instructions are for execution by an engine in a multiprocessor engine.

13. A system for processing a plurality of instructions including at least one no operation (NOP) instruction, comprising:
circuitry operable to:
access the program; and
remove at least one NOP instruction in the program that is not needed to provide a processing delay to ensure data is available to at least one dependent instruction accessing the data.

14. The system of claim 13, wherein the operation to remove the at least one NOP instruction is further operable to:
delete one NOP instruction in the program that is not needed to provide the processing delay to ensure the data is available to at least one dependent instruction without moving a non-NOP instruction; and replace one NOP instruction with one determined instruction preceding the NOP instruction in response to determining that one instruction preceding at least one NOP instruction is capable of replacing the NOP instruction in the program.

15. The system of claim 13, wherein the circuitry is further operable to:
delete at least one instruction in the program that is not needed to provide the processing delay to ensure the data is available to at least one dependent instruction; and
after deleting the at least one instruction, replace at least one NOP instruction with one determined instruction preceding the at least one NOP instruction in response to determining that one instruction preceding at least one NOP instruction is capable of replacing the NOP instruction in the program.

16. The system of claim 15, wherein the circuitry is further operable to:
perform an additional iteration of deleting at least one instruction and then replacing the at least one NOP instruction in response to replacing at least one NOP instruction.

17. The system of claim 13, wherein the instructions in the program comprise assembly language instructions coded by a developer.

18. The system of claim 13, wherein the operation to remove NOP instructions in the program further comprises accessing and processing each NOP instruction to:
determine whether the accessed NOP instruction is needed to delay processing of one dependent instruction following the accessed NOP instruction to ensure that data is available to the dependent instruction accessing the data; and
delete the accessed NOP instruction in response to determining that the NOP instruction is not needed to ensure that data is available to the dependent instruction accessing the data.

19. The system of claim 18, wherein the operation to determine whether the accessed NOP instruction is needed to delay processing of one dependent instruction is further operable to:
identify instructions preceding the NOP instruction that have a delay in writing the results, and
identify dependent instructions following the NOP instruction that are dependent on an availability of data from the identified instructions having the delay in writing the results.

20. The system of claim 13, wherein the operation to remove NOP instructions in the program further accesses and processes each NOP instruction to:
replace the accessed NOP instruction with one previous non-NOP instruction that is capable of being moved forward to replace the accessed NOP instruction without preventing data from being available to one dependent instruction following the NOP instruction.

21. The system of claim 21, wherein the one previous instruction comprises a preceding instruction closest to the accessed NOP instruction in the program.

22. The system of claim 13, wherein the operation to remove the NOP instructions is further operable to:
delete at least one NOP instruction not needed to ensure that data accessed by the dependent instruction is available to the dependent instruction, wherein the operations of replacing accessed NOP instructions with previous non-NOP instructions are performed after deleting NOP instructions not needed to ensure that data accessed by the dependent instruction is available.

23. The system of claim 13, wherein the operation to remove NOP instructions in the program further accesses each NOP instruction to:
replace the accessed NOP instruction with one previous non-NOP instruction that is capable of being moved forward to replace the accessed NOP instruction without preventing data from being available to one dependent instruction following the NOP instruction and that is not a branch target instruction.

24. An article of manufacture enabled to:
access a program comprising a plurality of instructions including at least one no operation (NOP) instruction; and
remove at least one NOP instruction in the program that is not needed to provide a processing delay to ensure data is available to at least one dependent instruction accessing the data.

25. The article of manufacture of claim 24, wherein the operation to remove the at least one NOP instruction is further operable to:
delete one NOP instruction in the program that is not needed to provide the processing delay to ensure the data is available to at least one dependent instruction without moving a non-NOP instruction; and
replace one NOP instruction with one determined instruction preceding the NOP instruction in response to determining that one instruction preceding at least one NOP instruction is capable of replacing the NOP instruction in the program.

26. The article of manufacture of claim 24, wherein the article of manufacture is further operable to:
delete at least one instruction in the program that is not needed to provide the processing delay to ensure the data is available to at least one dependent instruction; and
after deleting the at least one instruction, replace at least one NOP instruction with one determined instruction preceding the at least one NOP instruction in response to determining that one instruction preceding at least one NOP instruction is capable of replacing the NOP instruction in the program.

27. The article of manufacture of claim 26, wherein the article of manufacture is further operable to:
perform an additional iteration of deleting at least one instruction and then replacing the at least one NOP instruction in response to replacing at least one NOP instruction.

28. The article of manufacture of claim 24, wherein the instructions in the program comprise assembly language instructions coded by a developer.

29. The article of manufacture of claim 24, wherein the operation to remove NOP instructions in the program further accesses and processes each NOP instruction to:
determine whether the accessed NOP instruction is needed to delay processing of one dependent instruction following the accessed NOP instruction to ensure that data is available to the dependent instruction accessing the data; and
delete the accessed NOP instruction in response to determining that the NOP instruction is not needed to ensure that data is available to the dependent instruction accessing the data.

30. The article of manufacture of claim 29, wherein the operation to determine whether the accessed NOP instruction is needed to delay processing of one dependent instruction is further operable to:
identify instructions preceding the NOP instruction that have a delay in writing the results, and
identify dependent instructions following the NOP instruction that are dependent on a availability of data from the identified instructions having the delay in writing the results.

31. The article of manufacture of claim 24, wherein the operation to remove NOP instructions in the program further accesses and processes each NOP instruction to:
replace the accessed NOP instruction with one previous non-NOP instruction that is capable of being moved forward to replace the accessed NOP instruction without preventing data from being available to one dependent instruction following the NOP instruction.

32. The article of manufacture of claim 31, wherein the one previous instruction comprises a preceding instruction closest to the accessed NOP instruction in the program.

33. The article of manufacture of claim 31, wherein the operation to remove the NOP instructions is further operable to:
delete at least one NOP instruction not needed to ensure that data accessed by the dependent instruction is available to the dependent instruction, wherein the operations of replacing accessed NOP instructions with previous non-NOP instructions are performed after deleting NOP instructions not needed to ensure that data accessed by the dependent instruction is available.

34. The article of manufacture of claim 24, wherein the operation to remove NOP instructions in the program further accesses each NOP instruction to:
replace the accessed NOP instruction with one previous non-NOP instruction that is capable of being moved forward to replace the accessed NOP instruction without preventing data from being available to one dependent instruction following the NOP instruction and that is not a branch target instruction.

35. The article of manufacture of claim 24, wherein the program instructions are for execution by an engine in a multiprocessor engine.
